(19) United States
(12) Patent Application Publication
(10) Pub. No.: US 2012/0014375 A1
(43) Pub. Date: Jan. 19, 2012

(54) Method for Telephone Connection Preservation

(75) Inventors: Renato Pinheiro Simoes, Fortaleza-CE (BR); Pier Angelo Tognini Filho, Goiania-GO (BR); Brian Scot Hillis, Centennial, CO (US)

(73) Assignee: AVAYA INC., Basking Ridge, NJ (US)

(21) Appl. No.: 12/837,680

(22) Filed: Jul. 16, 2010

(51) Int. Cl. H04L 12/66

(52) U.S. Cl. 370/352

(57) ABSTRACT

A method is provided in which a server is placed in the communication flow between a first communication terminal and a second communication terminal. The server executes connection preservation software which operates to keep the second communication terminal connected when the first communication terminal shuts down its communication software (e.g., VoIP application, etc.). Specifically, the connection preservation software transmits signaling that causes the connection to be transferred from the first communication terminal to a communication network node and vice versa.

### FIELD OF THE INVENTION

The present invention relates to telecommunications in general, and, more particularly, to connection preservation.

### BACKGROUND OF THE INVENTION

Modern cellular telephones can connect to both the Public Switched Telephone Network (PSTN) and the Internet. Telephone calls made over the Internet are oftentimes less expensive than telephone calls made over the PSTN.

Voice over Internet Protocol (VoIP) applications enable the conduct of telephone calls over the Internet. Users can download and install VoIP applications on their cellular telephones just as they can email clients and video games. A notable VoIP application is Skype™.

On some cellular telephones, however, only one software application can be running at a given time. These cellular telephones do not support the minimizing of one application and running it in the background while another application is being used. If a VoIP application is used to conduct a communication session, the VoIP application cannot be minimized in order for the user to interact with other applications. This poses a problem.

Suppose a user is talking on a cellular telephone to a far-end party. Also suppose that the user wants to move away from the VoIP telephony application for a second in order to check his or her email. In order to accomplish this task, the user has to close the VoIP telephony application first and then open the email client. When the VoIP application is closed, however, the far-end party is disconnected. This is inconvenient to the far-end party.

Therefore, the need exists for a method that would enable the termination of communication software without disconnecting far-end parties that are communicating with the communication software.

### SUMMARY OF THE INVENTION

The present invention addresses this need by placing a server in the communication flow between a first communication terminal and a second communication terminal. The server executes connection preservation software which operates to keep the second communication terminal connected when the first communication terminal shuts down its communication software (e.g., VoIP application, etc.). Specifically, the connection preservation software transmits signaling that causes the connection to be transferred from the first communication terminal to a communication network node and vice versa.

When the communication session is transferred to the communication network node, the first communication terminal can shut down its communication software without causing the second communication terminal to experience a termination of the connection. While the communication software is shut down, the communication network node will maintain the connection with the second communication terminal. When the first communication terminal restarts its communication software, the communication session with the second terminal is transferred back from the communication network node to the first terminal.

For example, if the present invention is used, when the user closes the VoIP application to check his or her email, a “remote-hold” signal is transmitted by the communication terminal of the user to the connection preservation software. In response to the remote-hold signal, the connection preservation software will transfer the connection away from the first terminal to a communication network node, which will maintain the communication session with the far-end party on behalf of the user.

When the user finishes checking his or her email, the user will restart the VoIP application. When the VoIP application is restarted, a “remove-hold” signal is transmitted to the connection preservation software by the communication terminal of the user. In response to the remove-hold signal, the connection preservation software will transfer the communication session back to the user, so that the user can resume his or her communications with the far-end party. At all times, the far-end party is connected to either the user or the communication network node. The communication session is never terminated with respect to the far-end party.

In some embodiments of the present invention, a user interface for a communication terminal is provided that comprises a first button. The pressing of the first button causes the terminal to transmit signaling that induces underlying communication infrastructure to maintain an ongoing communication session with a far-end party on behalf of the terminal. For instance, the pressing of the button for a first time causes the terminal to transmit a remote-hold signal to the server running the connection preservation software. The pressing of the button for a second time causes the first terminal to transmit a remove-hold signal to the same server.

For the purposes of this disclosure, the term “underlying network infrastructure” is defined as one or more nodes in a communication network, wherein the communication network is responsible for providing a communication capability to a communication terminal. Examples of communication capabilities include, but are not limited to, telephone call capability, video call capability, teleconferencing capability, and others.

It is to be understood that the above embodiments and their instances are provided to better illustrate different aspects of the present invention. They are in no way exhaustive of the full scope of the invention. The following disclosure teaches examples of some embodiments of the present invention in detail.

### BRIEF DESCRIPTION OF THE DRAWINGS

FIG. 1 depicts a schematic diagram of the salient components of the illustrative embodiment of the present invention.

FIG. 2A depicts a drawing of the salient components of the user interface of terminal 110.

FIG. 2B depicts a state diagram of possible state which terminal 110 can assume.

FIG. 3A depicts a schematic diagram of the salient hardware components of terminal 110.

FIG. 3B depicts a schematic diagram of the salient software components of terminal 110.

FIG. 4A depicts a schematic diagram of the salient hardware components of server 140.

FIG. 4B depicts a schematic diagram of the salient software components of server 140.

FIG. 5 depicts a sequence diagram of the interactions between terminal 110, server 140, node 130, and terminal 120 which take place in the illustrative embodiment of the present invention.

FIG. 6 depicts a flowchart of the execution of the salient tasks associated with the operation of the illustrative embodiment of the present invention.

FIG. 7 depicts a flowchart of the execution of the salient sub-tasks associated with the performance of task 630.

FIG. 8 depicts a flowchart of the execution of the salient sub-tasks associated with the performance of task 650.

### DETAILED DESCRIPTION

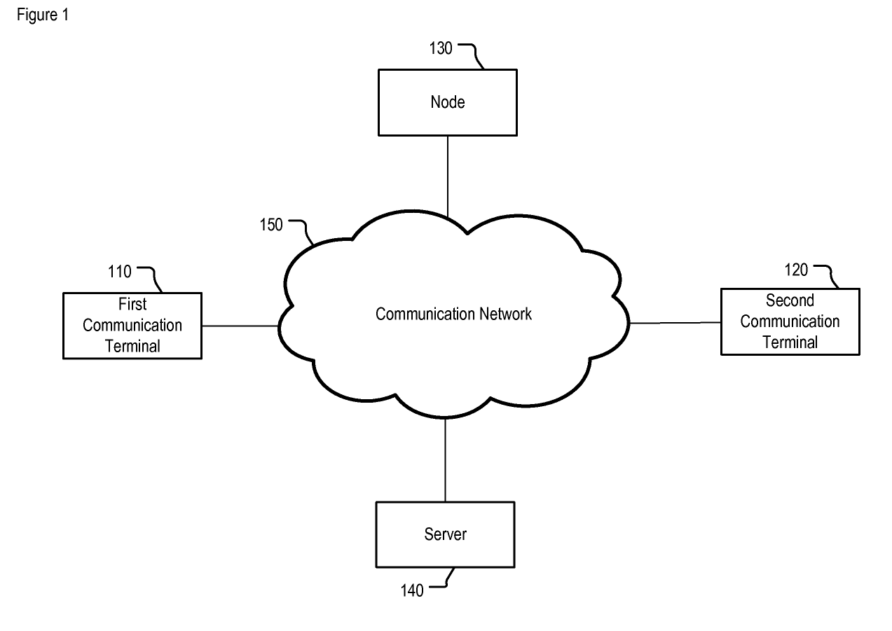

FIG. 1 depicts a schematic diagram of the salient components of the illustrative embodiment of the present invention. The illustrative embodiment comprises server 140, node 130, terminal 110, terminal 120, and network 150.

Server 140 is a Session Initiation Protocol (SIP) proxy server with enhanced connection-preservation capabilities. Server 140 can be any type of Session Initiation Protocol (SIP) server (e.g., proxy, registrar, redirect server, etc.). Although server 140 is a SIP server in the illustrative embodiment, those skilled in the art will recognize, after reading this disclosure, that alternative embodiments of the present invention can be devised in which server 140 operates according to another communication protocol (e.g., SS7, H.323, etc.).

In operation, server 140 performs at least one of two functions: (1) connection set-up and (2) connection preservation. With regard to its connection-setting function, server 140 receives and transmits signaling from terminals 110 and 120 and uses it to establish a communication session between the terminals. In accordance with the illustrative embodiment of the present invention, the communication session is a telephone call. It will be clear to those skilled in the art, after reading this disclosure, how to make and use alternative embodiments of the present invention in which the communication session is of any other type (e.g., video call, teleconference, text chat, video conference, etc.).

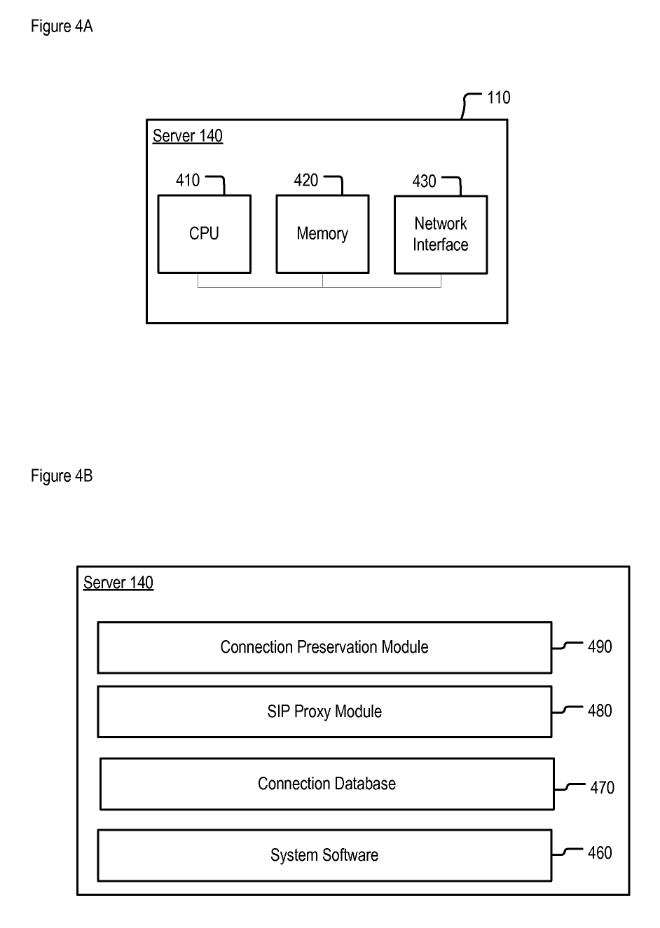

With regard to its connection preservation function, server 140 receives and transmits signaling that is used to transfer the telephone call from terminal 110 to node 130. The transferring of the telephone call results in the establishment of a media connection between terminal 120 and node 130. The media connection is maintained until server 140 receives a remove-hold signal. When the remove-hold signal is received, server 140 transfers the call back to terminal 110. The operation of server 140 is described in further detail in the discussion with respect to FIG. 4-8.

Node 130 is a communication network node (e.g., server, etc.). In the illustrative embodiment, node 130 is executing software that is capable of maintaining a media connection with terminal 120. The operation of node 130 is further described in the discussion with respect to FIGS. 4-8. Although in the illustrative embodiment of the present invention, server 140 and node 130 are separate hardware devices, it will be clear to those skilled in the art, after reading this disclosure, how to make and use alternative embodiments of the present invention in which node 130 and server 140 are integrated.

Both node 130 and server 140 are nodes in a communications network that communications capability to terminal 110. As such, each one of them is an example of “underlying network infrastructure.” In the illustrative embodiment, this network is a Voice over Internet Protocol (VoIP) network, but it will be clear to those skilled in the art, after reading this disclosure, how to make and use alternative embodiments of the present invention, in which node 130 and server 140 are nodes in any other type of communications network (e.g., cellular network, public switched telephone network, local network of a private branch exchange system, etc.).

Terminal 110 and terminal 120 are cellular telephones. Those skilled in the art will recognize, after reading this disclosure, how to make and use alternative embodiments of the present invention in which one or both of the terminals is another communication device, such as, for example, and without limitation, a smart phone, desk set telephone receiver, portable digital assistant (PDA), media streaming server, desktop computer, etc. In the illustrative embodiment of the present invention, terminals 110 and 120 use the Session Initiation Protocol (SIP). But it will be clear to those skilled in the art, after reading this disclosure, how to make and use alternative embodiments of the present invention in which any signaling protocol is used (e.g., ss7, H.323, etc.).

Network 150 is a communications network that transports signals between terminal 110, terminal 120, node 130, and server 140. In accordance with the illustrative embodiment of the present invention, network 150 is the Internet, but it will be clear to those skilled in the art, after reading this disclosure, how to make and use alternative embodiments of the present invention in which network 150 is another type of communication network (e.g. a local area network, the Public Switched Telephone Network, a cellular network, wide area network, etc.).

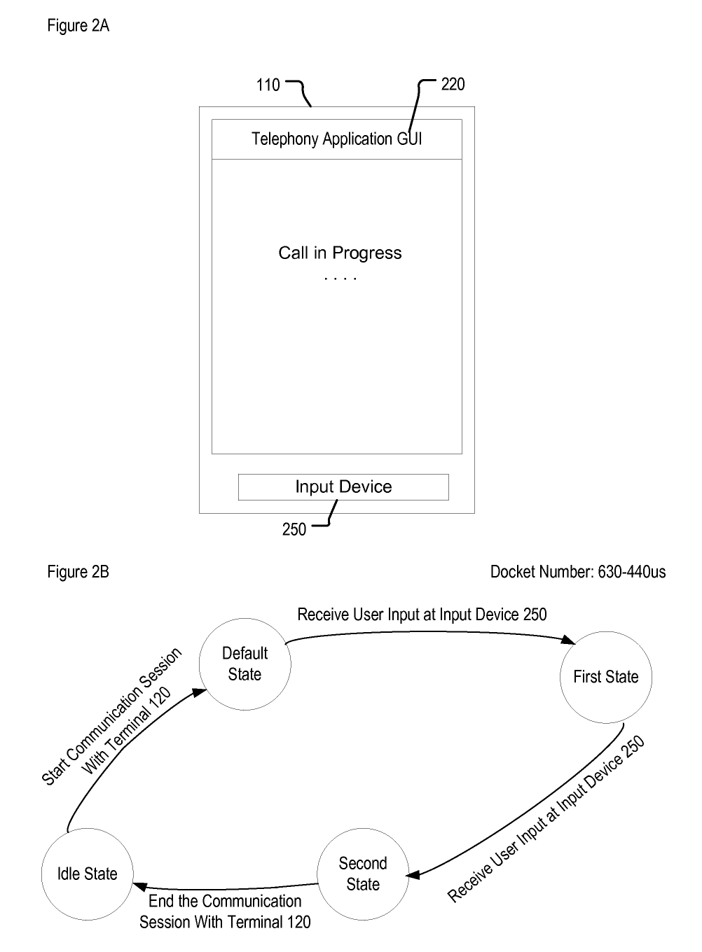

FIG. 2A depicts a drawing of the salient components of the user interface of terminal 110. Terminal 110 comprises display 220 and input device 250.

Display 220 is liquid crystal display (LCD).

Input device 250 is a button. The receipt of user input by input device 250 causes terminal 110 to transmit a signal that induces underlying communication infrastructure to maintain an ongoing communication session with a far-end party on behalf of terminal 110. While the ongoing communication session is maintained on its behalf, terminal 110 can go offline without the communication session being terminated. That is, terminal 110 can go offline (e.g., shut down telephony application 360, disconnect from network 150, shut down completely, etc.) without actually causing a termination of the communication session with respect to the far-end party.

In the illustrative embodiment of the present invention, terminal 110 has at least three states: a default, first, and second state. These states are depicted in FIG. 2B. When a telephone call, or another type of communication session, is initiated between terminal 110 and terminal 120, terminal 110 enters a default state. The receipt of user input by input device 250, when terminal 110 is in the default state, causes terminal 110 to transition to the first state. The receipt of user input on input device 250, when terminal 110 is in the first state, causes terminal 110 to transition to the second state.

When it transitions to the first state, terminal 110 transmits a “remote-hold” signal to server 140. Upon receiving the remote-hold signal, server 140 generates Session Initiation Protocol (SIP) signals to terminal 120 and node 130. The transmitted signals cause the call to be transferred from terminal 110 to node 130. In some embodiments, when terminal 110 is transitioning into the first state, terminal 110 also shuts down the communication application (e.g., telephony application 360, etc.) that is used for the conduct of the communication session between terminal 110 and terminal 120.

When it transitions from the first state to the second state, terminal 110 transmits to server 140 a “remove-hold” signal. Upon receiving the “remove-hold” signal, server 140 transmits SIP signaling that causes the telephone call to be transferred back to terminal 110. After the transfer is completed, terminal 110 can resume communications with terminal 120. In some embodiments, when terminal 110 transitions from the first state to the second state, terminal 110 also launches the communication application (e.g., telephony application 360, etc.) that is used for the conduct of the communication session between terminal 110 and terminal 120.

Although in the illustrative embodiment input device 250 is a button, it will be clear to those skilled in the art, after reading this disclosure, how to make and use alternative embodiments of the present invention in which input device 250 is any other device that is capable of receiving input from a user, such as, for example, and without limitation, click wheel, joystick, toggle switch, scroll wheel, slider, wheel, touch screen, accelerometer, etc. Furthermore, it will be clear to those skilled in the art, after reading this disclosure, how to make and use alternative embodiments of the present invention in which input device 250 is a graphical user interface (GUI) input component such as, for example, and without limitation, a graphical user interface (GUI) button, checkbox, icon, link, text input field, etc.

In the illustrative embodiment, the user input which causes terminal 110 to change states is the pressing of a button (i.e., input device 250). In alternative embodiments, however, the user input can be any other type of action, such as, for example and without limitation, the spinning of a wheel, the sliding of a slider, the entry of text input, the shaking of the terminal, etc.

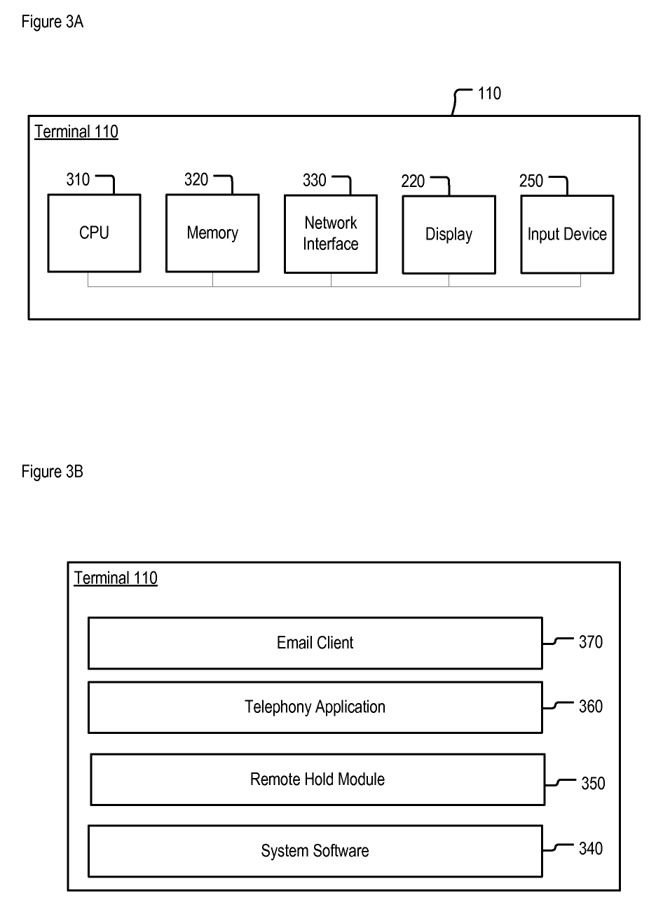

FIG. 3A depicts a schematic diagram of the salient hardware components of terminal 110. Terminal 110 comprises processor 310, memory 320, network interface 330, display 220, and input device 250.

Processor 310 is a central processing unit (CPU) configured to execute computer code. It will be clear to those skilled in the art how to make and use processor 310.

Memory 320 is a storage device that is addressable by processor 310. In accordance with the illustrative embodiment of the present invention, memory 320 is random access memory (RAM). It will be clear to those skilled in the art, after reading this disclosure, how to make and use alternative embodiments of the present invention in which memory 320 is any type of volatile or non-volatile storage device.

Network interface 330 is hardware that enables terminal 110 to transmit and receive communications over at least one communications network. It will be clear to those skilled in the art how to make and use network interface 330.

FIG. 3B depicts a schematic diagram of the salient software components of terminal 110. Terminal 110 comprises system software 340, remote hold module 350, telephony application 360, email client 370.

System software 340 is operating system software.

Remote-hold module 350 is software that causes remote-hold and remove-hold signals to be generated in the manner described with respect to FIGS. 2A and 2B. More specifically, when input device 250 receives user input while terminal 110 is in the default state, remote hold module 250 generates a remote-hold signal. When input device 250 receives user input while terminal 110 is in the first state, remote-hold module 350 generates a remove-hold signal.

Telephony application 360 is software for the conduct of telephone calls. It will be clear to those skilled in the art, after reading this disclosure, how to make and use alternative embodiments of the present invention in which telephony application 360 is capable of conducting any other type of communication session (e.g., video calls, text chat sessions, etc.).

FIG. 4A depicts a schematic diagram of the salient hardware components of server 140. Server 140 comprises processor 410, memory 420, and network interface 430.

Processor 410 is a central processing unit (CPU) configured to execute computer code. It will be clear to those skilled in the art how to make and use processor 410.

Memory 420 is a storage device that is addressable by processor 410. In accordance with the illustrative embodiment of the present invention, memory 420 is random access memory (RAM). It will be clear to those skilled in the art, after reading this disclosure, how to make and use alternative embodiments of the present invention in which memory 420 is any type of volatile or non-volatile storage device.

Network interface 430 is hardware that enables server 140 to transmit and receive communications over at least one communications network. It will be clear to those skilled in the art how to make and use network interface 430.

FIG. 4B depicts a schematic diagram of the salient software components of server 140. Server 140 comprises system software 460, database 470, connection preservation module 490, and SIP proxy module 480.

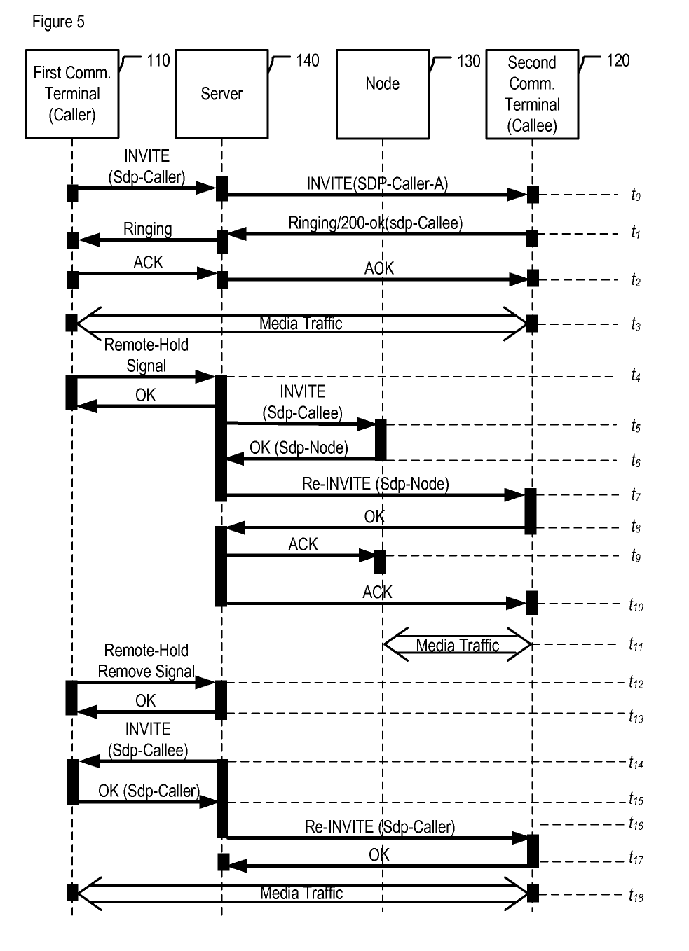

Connection preservation module 490 is software that is operable to receive remote-hold and remove-hold signals from remote hold module 350. Furthermore, connection preservation module 490 is operable to take action in response to the receipt of the signals. The operation of connection preservation module 490 is described in the discussion with respect to FIG. 5.

SIP proxy module 480 is software that performs the functions of a SIP proxy. It will be clear to those skilled in the art how to make and use SIP proxy module 480.

Database 470 is software for receiving and storing information about communication sessions that are enhanced by the services of connection preservation module 490. In accordance with the illustrative embodiment of the present invention, database 470 comprises the following record:

TABLE 1
Exemplary record from database 270

| | |
|---|---|
| Participants | Terminal 110, Terminal 120 |
| Protocol Used | SIP |
| Status of | Underlying Communication Infrastructure is |
| Communication | Currently Maintaining the Communication |
| Session | Session on Behalf of a Participant |
| Users Put on Hold | Terminal 120 |
| Id of Connection that | Connection_id=“11223344” |
| is Used to Keep the | |
| Users on Hold | |

In accordance with the illustrative embodiment of the present invention, database 470 stores five (5) types of information. It identifies the participants in a communication session, type of protocol used, status of the connection, whether terminal 120 is put on hold, and an identifier for the connection which is used to keep terminal 120 on hold. It will be clear to those skilled in the art, after reading this disclosure, how to make and use alternative embodiments of the present invention in which any item of information concerning communication sessions between terminal 110 and terminal 120 is recorded in database 470.

System software 460 is operating system software.

FIG. 5 depicts a sequence diagram of the salient interactions between terminal 110, server 140, node 130, and terminal 120 that take place in the illustrative embodiment of the present invention.

At time t₀, terminal 110 transmits an INVITE message directed to terminal 120. The INVITE message is received by SIP proxy module 480 and forwarded to terminal 120. In accordance with the illustrative embodiment, the INVITE message contains contact information for terminal 110. The contact information is carried inside a Session Description Protocol (SDP) message. The SDP message is encapsulated inside the INVITE message. The contact information for terminal 110 is denoted “Sdp-Caller” in the sequence diagram.

For the purposes of this disclosure, the term “contact information” is defined as information which is used in establishing a communication session that is used for the transmission of real-time media. Examples of contact information include IP addresses, port numbers, codec identifications, encryption keys, bandwidth information, session name, and others. Contact information includes, but is not limited to, the streaming media initialization attributes that are identified inside Session Description Protocol (SDP) messages. (See, e.g., SDP: Session Description Protocol, RFC 4566, etc.).

At time t₁, in response to receiving the INVITE message, terminal 120 transmits an OK message indicating that the terminal is accepting the invitation to participate in a communication session with terminal 110. The OK message is received by SIP proxy module 480 and forwarded to terminal 110. In the illustrative embodiment, the OK message contains contact information for terminal 120. The contact information is carried inside an SDP portion of the OK message. The contact information for terminal 120 is denoted “Sdp-Callee” in the sequence diagram.

At time t₂, terminal 110 transmits an ACK message. The ACK message is received by SIP proxy module 480 and forwarded to terminal 120.

At time t₃, a media connection is established between terminal 110 and terminal 120. In the illustrative embodiment of the present invention, the media connection carries voice communications. In alternative embodiments, however, the media connection is used to carry other type of media (e.g., video, text, etc.).

At time t₄, remote hold module 350 transmits to server 140 a remote-hold signal. In the illustrative embodiment, as noted, the remote-hold signal is transmitted by remote hold module 350 when input device 250 receives user input. It will be clear to those skilled in the art, however, that alternative embodiments of the present invention can be devised in which the remote-hold signal is transmitted when another event has occurred. Examples of such events include the shutting down of telephony application 360, the launching of an application other than telephony application 360, the generation of an exception by software that is executing on terminal 110 (e.g., system software 340, telephony application 360, email client 370, etc.), disruption in the connectivity of terminal 110 to network 150, and others.

In response, to the remote-hold signal, connection preservation module 490 transmits an OK message to terminal 110 indicating the receipt of the remote-hold signal.

At time t₅, connection preservation module 490 transmits an INVITE message to node 130. The invite message contains contact information of terminal 120. The contact information of terminal 120 is used in establishing a media connection between node 130 and terminal 120. In the illustrative embodiment, the contact information is contained inside an SDP message that is encapsulated by the INVITE message.

At time t₆, connection preservation module 490 receives an OK message from node 130. The OK message contains contact information of node 130. The contact information of node 130 is used in establishing a media connection between node 130 and terminal 120. In the illustrative embodiment, the contact information is contained inside an SDP message that is encapsulated by the OK message. The contact information for node 130 is denoted “Sdp-Node” in the sequence diagram.

At time t₇, connection preservation module 490 transmits a re-INVITE message to terminal 120. The re-INVITE message contains the contact information of node 130 that is received by server 140 at time t₁. In the illustrative embodiment, the contact information of node 130 is encapsulated inside an SDP message that is encapsulated inside the re-INVITE message.

As is well known, SIP re-INVITE messages are used to modify characteristic(s) of ongoing communication sessions. In the illustrative embodiment, the re-invite message is used to replace terminal 110 with node 130 in the communication session with terminal 120. Put differently, the SIP re-INVITE message is used to transfer the communication session from terminal 110 to node 130.

After the connection is transferred terminal 110 can shut down telephony application 360, or perform any other action that would ordinarily have terminated the communication session initiated at times t₀-t₃. Because terminal 120 is connected to node 130, when such action is performed, the communication session is not going to be dissolved. Node 130 will keep the communication session alive until a remove-hold signal is received from terminal 110, at which time terminals 110 and 120 would be reconnected.

At time t₀, connection preservation module 490 receives an OK message acknowledging the receipt of the re-INVITE transmitted at time t₇.

At time t₉, connection preservation module 490 transmits an ACK message to node 130.

At time t₁₀, connection preservation module 490 transmits an ACK message to terminal 120.

At time t₁₁, the media connection between terminal 110 and terminal 120 is modified, so that that node 130 is added as a participant in the place of terminal 110. In other words, at time t₁₁, the telephone call is transferred to node 130.

In the illustrative embodiment of the present invention, the communication session is modified by terminating the media connection between terminal 110 and terminal 120 and starting a new media connection in its place between terminal 120 and node 130. The present invention, however, is not limited to this approach specifically. It will be clear to those skilled in the art, after reading this disclosure, how to make and use alternative embodiment of the present invention, in which the transfer of the communication session from terminal 110 to node 130 is executed by using any method for call transferring and/or forwarding that is provided by the communication protocol used. (e.g., H.450.2 when H.323 is used, etc.).

At time t₁₂, connection preservation module 490 receives a remove-hold signal. In the illustrative embodiment, the remove-hold signal is a SIP register message which terminal 110 transmits to server 140 when telephony application 360 is launched.

In the illustrative embodiment of the present invention, the remove-hold signal is a SIP REGISTER message. It will be clear to those skilled in the art, however, that alternative embodiments of the present invention can be devised in which the remove-hold signal can be any type of message. It will also be clear to those skilled in the art, how to make and use alternative embodiments of the present invention in which the remove-hold signal is transmitted when another triggering event occurs. Examples of such events include the termination of another communication session in which terminal 110 is participating (e.g., the termination of an Internet chat session, the termination of another telephone call, etc.), the shutting down of a software application that is launched after the commencing of the media connection at time t₃ (e.g., email client, chat client, etc.), and others.

At time t₁₃, connection preservation module 490 transmits to terminal 110 an OK message acknowledging receipt of the remove-hold signal.

At time t₁₄, connection preservation module 490 transmits to terminal 110 an INVITE message. The invite message contains the contact information of terminal 120. The contact information is contained in an SDP message that is encapsulated by the INVITE message.

At time t₁₅, connection preservation module 490 receives from terminal 110 an OK message containing the contact information of terminal 110. The contact information is contained in an SDP message that is encapsulated by the INVITE message.

At time t₁₆, connection preservation module 490 transmits to terminal 140 a re-INVITE message containing the contact information of terminal 110. The contact information is contained in an SDP message that is encapsulated by the re-INVITE message. The re-INVITE message is used to modify the characteristics of the media connection between node 130 and terminal 120. More specifically, the re-INVITE message is used to replace node 130 with terminal 110 as a participant in the communication session with terminal 120. Put differently, the re-INVITE message is used to transfer the telephone call back to terminal 110.

In the illustrative embodiment of the present invention, the communication session is modified by terminating the media connection between terminal 120 and node 130 and starting a new media connection in its place between terminal 110 and terminal 120. The present invention, however, is not limited to this approach specifically. It will be clear to those skilled in the art, after reading this disclosure, how to make and use alternative embodiment of the present invention, in which the transfer of the communication session from terminal 130 to node 110 is executed by using any method for call transferring and/or forwarding that is provided by the communication protocol used. (e.g., H.450.2 when H.323 is used, etc.).

At time t₁₇, connection preservation module 490 receives from terminal 120 an OK message acknowledging receipt of the re-INVITE message transmitted at time t₁₆.

At time t₁₈, the media connection between terminal 110 and terminal 120 is modified, so that that terminal 110 is added as a participant in the place of node 130. At time t₁₁, terminal 120 resumes communicating with terminal 110.

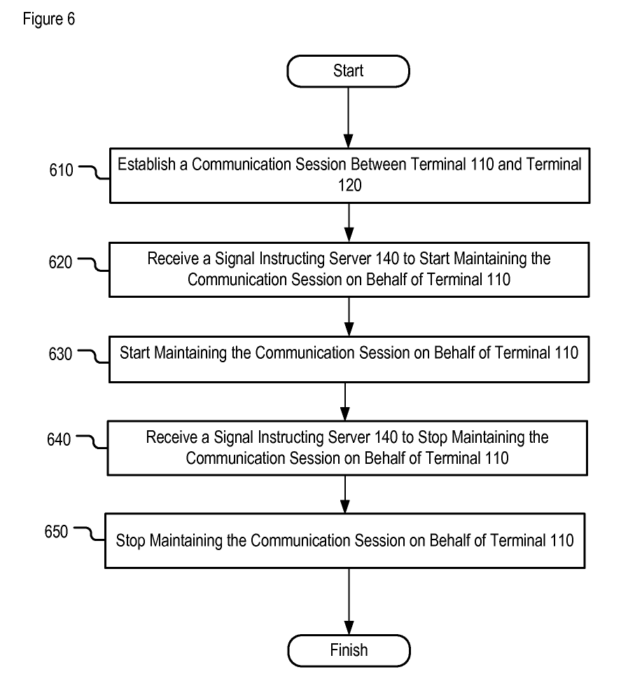

FIG. 6 depicts a flowchart of the execution of the salient tasks associated with the operation of the illustrative embodiment of the present invention.

At task 610, a communication session between terminal 110 and terminal 120 is established. In the illustrative embodiment, the communication session is established by using the services of SIP proxy module 480 in the manner described in the discussion with respect to FIG. 5. In alternative embodiments, however, the communication session is established without the involvement of SIP proxy module 480 or server 140.

Furthermore, in accordance with the illustrative embodiment of the present invention, the communication session uses the Session Initiation Protocol (SIP). It will be clear to those skilled in the art, however, how to make and use alternative embodiments of the present invention in which another communication protocol is used (e.g., H.323, ss7, etc.).

At task 620, server 140 receives a remote-hold signal from terminal 110. The remote-hold signal is a message which instructs underlying network infrastructure (e.g., server 140, etc.) to maintain an ongoing communication session on behalf of terminal 110. In the illustrative embodiment, the remote-hold signal instructs server 140 to transfer the communication session from terminal 110 to node 130. Although, in the illustrative embodiment of the present invention, the remote-hold signal is a message, it will be clear to those skilled in the art, after reading this disclosure, how to make and use alternative embodiments of the present invention in which the remote-hold signal can be any type of signal (e.g., a tone, pulse, etc.).

In the illustrative embodiment, the remote-hold signal is transmitted when input device 250 receives user input in the fashion described with respect to FIGS. 2A and 2B. It will be clear to those skilled in the art, after reading this disclosure, that alternative embodiments of the present invention can be devised in which the remote-hold signal is transmitted in response to another triggering event. Examples of such events include the shutting down of telephony application 360, the launching of an application other than telephony application 360, the generation of an exception by software that is executing on terminal 110 (e.g., system software 340, telephony application 360, email client 370, etc.), disruption in the connectivity of terminal 110 to network 150, and others.

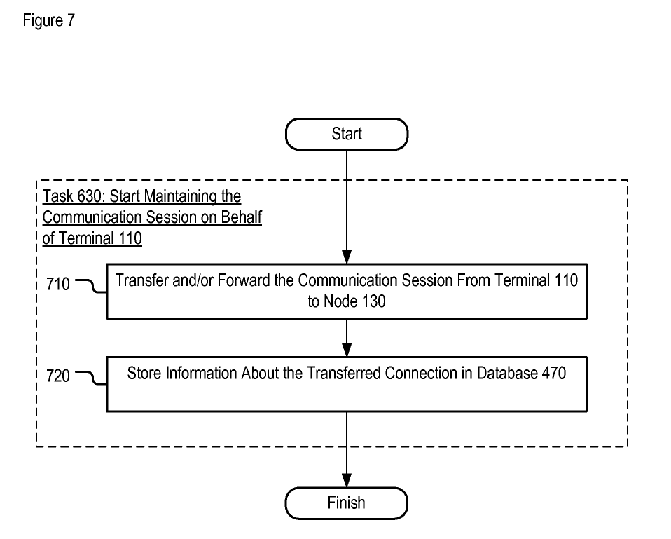

At task 630, server 140 starts maintaining the communication session on behalf of terminal 110. In the illustrative embodiment, server 140 establishes a media connection between terminal 120 and node 130, wherein the established media connection is part of the communication session initiated at task 610. After the media connection is established, terminal 110 can temporarily go offline (e.g., shut down telephony application 360, disconnect from network 150, shut down completely, etc.) without terminal 120 becoming disconnected. Task 630 is further described in the discussion with respect to FIG. 7.

At task 640, server 140 receives a remove-hold signal from terminal 110. The remove-hold signal is a message which instructs underlying network infrastructure (e.g., server 140, etc.) to restore the connection between terminal 110 and terminal 120. As noted, the remove-hold signal is a SIP REGISTER message. It will be clear to those skilled in the art, however, that alternative embodiments of the present invention can be devised in which the remove-hold signal can be any type of message. Although, in the illustrative embodiment of the present invention, the remote-hold signal is a message, it will be clear to those skilled in the art, after reading this disclosure, how to make and use alternative embodiments of the present invention in which the remote-hold signal can be any type of signal (e.g., a tone, pulse, etc.).

In the illustrative embodiment, the remove-hold signal is transmitted when input device 250 receives user input in the fashion described with respect to FIGS. 2A and 2B. It will be clear to those skilled in the art, after reading this disclosure, that alternative embodiments of the present invention can be devised in which the remove-hold signal is transmitted in response to another triggering event. Examples of such events include the termination of another communication session in which terminal 110 is participating (e.g., the termination of an Internet chat session, the termination of another telephone call, etc.), the termination of a software application that is launched after the commencing of the media connection at time t₃ (e.g., email client, chat client, etc.), and others.

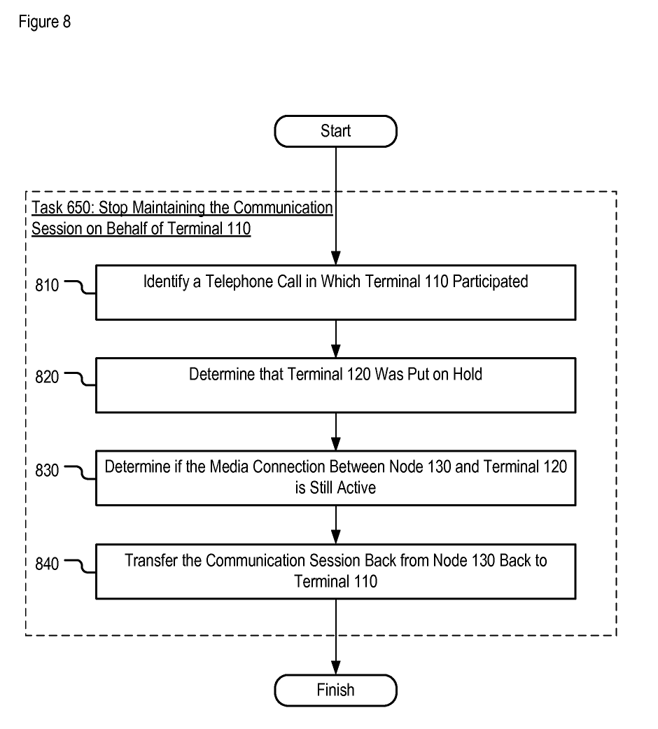

At task 650, terminal 140 reconnects terminal 110 with terminal 120. Task 650 is further described in the discussion with respect to FIG. 8.

Tasks 610-650 are described for illustrative purposes. It will be clear to those skilled in the art, after reading this disclosure, how to perform the tasks associated with FIG. 6 in a different order than represented or to perform one or more of the tasks concurrently. Furthermore, it will be clear to those skilled in the art, after reading this disclosure, how to make and use alternative embodiments of the present invention that omit one or more of the tasks.

FIG. 7 depicts a flowchart of the execution of the salient sub-tasks associated with the performance of task 630.

At task 710, server 140 transfers the communication session from terminal 110 to node 130. Server 140 transmits signaling which causes terminal 120 and node 130 to establish a media connection with each other. In the illustrative embodiment of the present invention, the transfer is accomplished in the manner described in the discussion with respect to FIG. 5. It will be clear to those skilled in the art, however, that alternative embodiments of the present invention can be devised in which server 140 causes terminal 120 and node 130 to start communicating with each other by using any transfer and/or call forwarding technique known in the art.

At task 720, server 140 stores information about the transferred communication session in database 470. In the illustrative embodiment, server 140 creates and stores a record that contains an ID for the connection. Also, the record identifies the participants in the communications session and contains an indication that the communication session has been transferred following a transmission of a remote-hold signal by terminal 110.

Tasks 710-720 are described for illustrative purposes. It will be clear to those skilled in the art, after reading this disclosure, how to perform the tasks associated with FIG. 7 in a different order than represented or to perform one or more of the tasks concurrently. Furthermore, it will be clear to those skilled in the art, after reading this disclosure, how to make and use alternative embodiments of the present invention that omit one or more of the tasks.

FIG. 8 depicts a flowchart of the execution of the salient sub-tasks associated with the performance of task 650. In the illustrative embodiment, the tasks of FIG. 8 are performed in response to the receipt of a remove-hold signal by server 140.

At task 810, connection preservation module 490 identifies a past communication in which terminal 110 participated. In accordance with the illustrative embodiment of the present invention, connection preservation module 490 consults database 470 and determines that terminal 110 participated in a communication session with terminal 120.

At task 820, connection preservation module 490 consults database 470 determines that the communication session between terminal 110 and terminal 120 was put on hold by underlying network infrastructure following the transmission of a remote-hold signal by terminal 110.

At task 830, connection preservation module 490 consults database 470 and determines that terminal 120 was put on hold by transferring the communications session from terminal 110 to node 130. Also, it determines that the media connection between terminal 120 and node 130 is still active.

At task 840, server 140 transfers the communication session from node 130 to terminal 110. In the illustrative embodiment of the present invention, the transfer is accomplished in the manner described in the discussion with respect to FIG. 5. It will be clear to those skilled in the art, however, that alternative embodiments of the present invention can be devised in which server 140 causes terminals 110 and 120 to start communicating with each other by using any other technique that is known in the art.

Tasks 810-840 are described for illustrative purposes. It will be clear to those skilled in the art, after reading this disclosure, how to perform the tasks associated with FIG. 8 in a different order than represented or to perform one or more of the tasks concurrently. Furthermore, it will be clear to those skilled in the art, after reading this disclosure, how to make and use alternative embodiments of the present invention that omit one or more of the tasks.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A communication terminal comprising:
an input device;
wherein, a receipt of user input at the input device causes the communication terminal to transmit an indication to underlying communication network infrastructure to start maintaining an ongoing communication session on behalf of the communication terminal; and
wherein the input device is part of the user interface of the communication terminal.

2. The method of claim 1 wherein the input device is one of a button, slider, toggle switch, click wheel, wheel, accelerometer, graphical user interface (GUI) button, graphical user interface (GUI) slider, and graphical user interface (GUI) text input field.

3. The communication terminal of claim 1 wherein the receipt of the user input at the input device also causes the communication terminal to shut down a software application that is used for the conduct of the communication session.

4. A communication terminal comprising:
an input device;
wherein, a receipt of user input at the input device while the communication terminal is in a first state causes the communication terminal to transmit a signal that induces underlying communication network infrastructure to start maintaining an ongoing communication session on behalf of the first communication terminal; and
wherein, a receipt of user input at the input device while the communication terminal is in a second state causes the communication terminal to transmit a signal that induces the underlying communication network infrastructure to stop maintaining an ongoing communication session on behalf of the first communication terminal and re-connect the first communication terminal with the second communication terminal.

5. The communication terminal of claim 1 wherein the receipt of the user input at the input device while the communication terminal is in the first state also causes the communication terminal to shut down a software application that is used for the conduct of the communication session.

6. The communication terminal of claim 1 wherein the receipt of the user input at the input device while the communication terminal is in the second state also causes the communication terminal to launch a software application that is used for the conduct of the communication session.

7. A method comprising:
establishing a communication session between a first communication terminal and a second communication terminal; and
when the first communication terminal detects that an event has occurred, transmitting from the first communication terminal an indication to underlying communication network infrastructure an indication to start maintaining an ongoing communication session on behalf of the first communication terminal.

8. The method of claim 7 wherein the event is a generation of an exception by software that is executing on the first communication terminal.

9. The method of claim 7 wherein the event is a generation of an exception by software that is executing on the first communication terminal, wherein the exception indicates that software has failed.

10. The method of claim 7 wherein the event is a generation of a hardware interrupt by a hardware component of the first communication terminal.

11. The method of claim 7 wherein the event is a generation of a hardware interrupt by a hardware component of the first communication terminal, wherein the interrupt indicates that the hardware component has failed.

12. The method of claim 7 wherein the event is loss of network coverage.

13. A method comprising:
receiving, at a first server from a first communication terminal a first signal;
in response to the first signal, transmitting from the first server communication protocol signaling that results in the establishment of a media connection between a communication network node and a second communication terminal, wherein the media connection is established as part of a communication session;
wherein the communication session is established prior to the execution of the transmitting task; and
wherein the communication session is originally established between the first communication terminal and the second communication terminal.

14. A method comprising:
receiving at time t₁, a message that indicates that a first communication terminal is willing to resume communicating with a second communication terminal;
in response to the receipt of the message, identifying a first media connection between a communication network node and the second communication terminal, wherein:
(a) the identified media connection is part of a communication session C which was initiated between the first communication terminal and the second communication terminal at time t₀.
(b) the first communication terminal is not a party to the communication session at time t₁;
establishing at time t₂ a second media connection between the first communication terminal and the second communication terminal, wherein the second media connection is established as part of the communication session C;
wherein t₀<t₁<t₂; and
wherein the receiving, identifying, and establishing tasks are performed by a server.

15. The method of claim 14 comprising terminating the first media connection.

16. The method of claim 14 wherein the communication session between the first communication terminal and the second communication terminal uses the Session Initiation Protocol (SIP).

17. The method of claim 14 wherein the establishing task comprises initiating a media connection between the first communication terminal and the second communication terminal, wherein the first media connection is distinct from the second media connection.
